(19) United States
(12) Patent Application Publication
(10) Pub. No.: US 2005/0143791 A1
(43) Pub. Date: Jun. 30, 2005

(54) Process of treating a cell

(76) Inventor: Stuart Hameroff, Tucson, AZ (US)

Correspondence Address: HOWARD J. GREENWALD P.C., 349 W. COMMERCIAL STREET SUITE 2490, EAST ROCHESTER, NY, 14445-2408, US

(21) Appl. No.: 11/020,390

(22) Filed: Dec. 22, 2004

Related U.S. Application Data
(63) Continuation-in-part of application No. 09/901,372, filed on Jul. 9, 2001.

(51) Int. Cl. A61H 33/00; A61H 21/00

(52) U.S. Cl. 607/86

(57) ABSTRACT

Included in this disclosure is a process for treating a cell in which the tubulin pattern of a centriole is caused to change in response to altering its physical state. In this manner, the tubulin pattern can be selective reprogrammed.

### CROSS-REFERENCE TO RELATED PATENT APPLICATIONS

This application is a continuation-in-part of co-pending patent application U.S. Ser. No. 09/901,372, filed on Aug. 9, 2001. The content of this application is hereby incorporated by reference into this specification.

### FIELD OF THE INVENTION

This invention relates, in one embodiment, to medical treatments of disease, and more particularly, to the treatment of cells undergoing abnormal mitosis and state of differentiation so as to restore their normal cellular cycle.

### BACKGROUND OF THE INVENTION

As is well known in the art, the cell cycle is divided into two stages; Interphase and Mitosis Phase (“M Phase”). Interphase is subdivided into three subphases (G1, S, and G2); the first gap phase, the S phase (wherein DNA is replicated) and the second gap phase. Centrosome replication occurs during interphase. As used in this specification, the term centrosome refers to the pair of cylinders which comprise the microtubule organizing center in most animal cells as well as the associated pericentrin matrix. The term centriole commonly refers to one of the two cylinders which comprise the centrosome. Common usage within the art also uses the term “centriole” to refer to the pair of cylinders (i.e. as a synonym for centrosome). As stated in the book entitled Molecular Biology of the Cell, fourth edition, by Bruce Alberts et al., Garland Science publishing, 2002, Chapter 8 on page 1031, “The process of centrosome duplication and separation is known as the centrosome cycle. During interphase of each animal cell cycle, the centrioles and other components of the centrosome are duplicated (by an unknown mechanism) but remain together as a single complex on one side of the nucleus. . . . As mitosis begins, this complex splits in two, and each centriole pair becomes part of a separate microtubule organizing center that nucleates a radial array of microtubules call an aster. . . . The two asters move to opposites sides of the nucleus to initiate the formation of the two poles of the mitotic spindle. When the nuclear envelope breaks down [during M phase], the spindle captures the chromosomes; it will separate them toward the end of mitosis. . . . As mitosis ends and the nuclear envelope re-forms around the separated chromosomes, each daughter cell receives a centrosome in association with its chromosomes.”

The M phase is itself divided into a series of phases. While there is debate over the exact number of phases, cellular biologists agree that the core phases include prophase, metaphase, anaphase, and telophase. During prophase, the chromosomes that were replicated during the S phase condense, with the homologous pairs being tied together with a kinetochore. Each member of this homologous pair is referred to as a “sister chromatid.” The each replicated centrosome migrates to opposite poles of the cell and sends out kinetochore microtubules which attached to the kinetochore of the replicated chromosomes.

During metaphase, the attachment of the microtubules to the kinetochores results in the alignment of the replicated chromosomes along the metaphasic plane. Each centrosome is attached to one chromosome of each homologous pair.

During anaphase, sister chromatids are then pulled apart into two identical sets of chromosomes by the mitotic spindles which attach to the chromatid kinetochore. Once separated, sister chromatids are known as daughter chromosomes. The cell cycle completes during telophase wherein cytokinesis occurs which forms two distinct, yet genetically identical, daughter cells.

Cellular biologists are uncertain as to how the cell manages to control the precise separation of chromotids during cell replication. As centrosomes and/or centrioles organize the spindles (which anchor in the pericentrin matrix surrounding centrioles), it is believed that centrosomes and/or centrioles are the primary organizers of mitosis. Theories have been suggested which point to an organizing force. A review in Science concluded: “Robustness of spindle assembly must come from guidance of the stochastic behavior of microtubules by a field” (Karsenti, E., Vernos, I.; The mitotic spindle: A self-made machine. Science vol. 294, pp. 543-547; 2001). Without any real evidence some conclude that chromosomes generate some type of field which organizes the centrioles and spindles. However Boveri (Boveri, T.; The origin of malignant tumors; J. B. Bailliere; London; 1929) and later Mazia (Regulatory mechanisms of cell division. Federation Proceedings vol. 29, no. 3, pp. 1245-7; 1970) believed the opposite, that spindle and centrosome/centriole microtubules generated an organizing field or otherwise regulated the movement of chromosomes and orchestration of mitosis.

In any case centrioles are essential to normal mitosis and impairment of their function can lead to genomic instability and cancer. Multiple and enlarged centrosomes have been found in cells of human breast cancer and other forms of malignancy (Lingle et al., J. am. Pathol. 155(6), 1941-1951, 1999; and Pihan et al., Cancer Res. 63(6), 1398-1404, 2003). Wong and Stearn (Nat. Cell Biol. 5(6) 539-544, 2003) showed that centrosome number, hence centriole replication, is controlled by factors intrinsic to the centrosome/centrioles (i.e. rather than genetic control).

Subsequent to mitosis, embryonic daughter cells develop into particular types of cells (phenotypes), e.g. nerve cells, blood cells, intestinal cells etc., a process called “differentiation”. Each (normal) cell in an organism has precisely the same set of genes. Differentiation involves “expressing” a particular subset of genes to yield a particular phenotype. Neighbor cells and location within a particular tissue somehow convey signals required for proper gene expression and differentiation. For example an undifferentiated “stem cell” placed in a certain tissue will differentiate to the type of cell in the surrounding tissue. However the signaling mechanisms conveyed by surrounding cells to regulate differentiation are unknown.

Cancer cells are often described as poorly differentiated, or undifferentiated—lacking refined properties characteristic of a particular tissue type, and unmatched to the surrounding or nearby normal tissue. Abnormal genotypes (e.g. from aberrant mitosis or mutations) can disrupt normal differentiation, but again the mechanisms of normal differentiation (genotype to phenotype) are unknown.

The Cause of Cancer

The root cause of cancer is likewise unknown. Gibbs opined that the materials typically associated with cancer (alcohol, sunshine, tobacco smoke, etc) are strong links, but not root causes. “A cause, by definition, leads invariably to its effect. . . . Much of the population is exposed to these carcinogens, yet only a tiny minority suffers dangerous tumors as a consequence” (Gibbs, W. W.; Untangling the roots of Cancer; Scientific American v 289, no. 1, pp 56-65 2003). The genesis of cancer must be something more fundamental.

It is well known that aneuploidy (abnormal numbers of chromosomes) is a hallmark of cancerous cells. “Standard Dogma” assumes that a genetic mutation has occurred in the DNA, and this mutation then alters the mitotic cell cycle resulting in aneuploidy. Thus, standard dogma asserts that aneuploidy is a result of cancer, not the cause. Specific alterations in a cell's DNA, spontaneous or induced by carcinogens, change the particular proteins encoded by cancer-related genes at those spots. Thus most presume cancer is based mainly on 1) oncogenes—genes which, if activated, cause cancer, and 2) suppressor genes—genes which normally prevent cancer and, if inactivated, result in cancer.

However in the era of genetic engineering, oncogene/suppressor theory has failed to explain cancer. No consistent set of gene mutations correlate with malignancy; each tumor may be unique in its genetic makeup. In fact tremendous genetic variability occurs within individual tumors, and genomic instability—changes in the genome with subsequent cycles of mitosis—is now seen as the major pathway to malignancy.

Some specific DNA factors are indeed related to genomic instability. These include unrepaired DNA damage, stalled DNA replication forks processed inappropriately by recombination enzymes, and defective telomeres which protect ends of chromosomes. But again, inherent DNA mutation and sequelae—the “standard dogma”—don't explain the entire picture. Other approaches suggest that a combination of DNA defects and other problems are responsible for genomic instability and malignancy.

“Modified dogma” revives an idea from 1974 by Lawrence A. Loeb and colleagues (Loeb et al., Cancer Res. 34(9) 2311-2321, 1974) who noted that random mutations, on average, would affect only one gene per cell in a lifetime. Some other factor—carcinogen, reactive oxidants, malfunction in DNA duplication and repair machinery—is proposed to increase the incidence of random mutations (Loeb et al., Proc. Natl. Acad. Sci, U.S.A. 100)3), 776-781, 2003). Another approach is “early instability” (Nowak et al., Proc. Natl. Acad. Sci. U.S.A. 99(25) 16226-16231, 2002) which suggests that master genes are critical to cell division—if they are mutated, mitosis is aberrant. But master genes are still merely proposals.

The “all-aneuploidy” theory (Duesberg et al., Cancer Genet. Cytogenet. 119 (2), 83-93, 2000) proposes that cells become malignant before any mutations or intrinsic genetic aberrancy. With the exception of leukemia, nearly all cancer cells are aneuploid. Thus malignancy is more closely related to maldistribution of chromosomes than to mutations on the genes within those chromosomes. Experiments show that genomic instability correlates with degree of aneuploidy.

Asbestos fibers and other carcinogenic agents are known to disrupt normal mitosis. Certain genes trigger and regulate mitosis, and experimentally induced mutations in these genes result in abnormal mitosis and malignancy. However such mutations in mitosis-regulating genes have not been found in spontaneously occurring cancers. Thus mitosis itself, the dynamical, ballet-like mechanical separation of chromosomes into two perfectly equal paired sets, may be at the heart of the problem of cancer. The organizational fields of mitosis are not understood.

The prior art has used photodynamic therapy to treat cancer. Photodynamic therapy (PDT) uses lasers to excite drug molecules to treat cancer. Reference may be had to U.S. Pat. Nos. 4,973,848; 6,149,671; and the like, the contents of which are hereby incorporated by reference into this specification. As is disclosed in U.S. Pat. No. 4,973,848, “Typically, the targets treated by this method will be from 1 to 15 cm in diameter and require 0.1 to 3.0 mW/square centimeter of laser power delivered to the target.” This is distinguished from the process of the instant invention which employs much lower power density levels. Likewise, PDT typically employs “chemicals which are selectively retained . . . by cancer cells.” The process of the instant invention requires no such chemicals.

Hyperthermia treatment seeks to treat cancerous tissues by selectively heating tumor cells beyond their viable limits. Such heating may be accomplished by a variety of means, including laser heating. Reference may be had to U.S. Pat. Nos. 6,701,175; 6,603,988; 6,290,712; 5,823,941; 6,503,268; 5,050,597; 6,143,535; 5,874,266; and the like. The content of each of these patents is hereby incorporated by reference into this specification. As is disclosed in U.S. Pat. No. 5,050,597 “According to this therapy, [a]laser beam is irradiated for 10 to 25 minutes to keep a cancer tissue at a temperature of 42° to 44° C. for letting the tissue die.” This approach is distinguished from the process of the instant invention which avoids both thermal therapy and tissue death. In one embodiment of the process the cells being treated do not undergo significant temperature increase. As would be apparent to one of ordinary skill in the art, a temperature increase is significant if it alters the viability of the cell in question (i.e. hyperthermia). In another embodiment, the cells are kept below a temperature of about 45 degrees. In another embodiment, the laser therapy is temporarily halted before the tissues reach a temperature of about 40 degrees.

Quantum Entanglement

Quantum entanglement (also referred to as quantum coherence) is a phenomenon wherein components of a system become unified (governed) by one common quantum wave function. The quantum states of each component in an entangled system must therefore be described with reference to other components, though they may be spatially separated. This leads to correlations between observable physical properties of the systems that are stronger than classical correlations. A pair of entangled electrons, for example, could “communicate” their spin states over vast differences.

Within the realm of quantum mechanics, the term “superposition” refers to the property of quantum particles to simultaneously exist in two quantum states (e.g. position, spin, polarization, and the like) at the same time. For example, an electron is known to exist either in a spin up or a spin down state. According to quantum mechanics, there is a third possibility, wherein the electron exists simultaneously as both spin up and spin down. Which of these spin states the electron is actually in is not realized until the electron spin is observed (measured). Electrons are known to preferentially exist as entangled pairs. At the moment of measurement, the particle's spin is set (“reduced”) and its entangled twin then “collapses” to the complementary spin state. This occurs regardless of the spatial distance between the entangled partners.

Einstein disliked entanglement (and quantum mechanics in general) deriding it as “spooky action at a distance”. Einstein, Podolsky and Rosen (Phy. Rev. 47, 777-780, 1935) formulated the “EPR paradox”: a thought experiment intended to disprove entanglement. Imagine two members of a quantum system (e.g. two paired electrons with complementary spin: if one is spin up, the other is spin down, and vice versa). If the paired electrons (both in superposition of both spin up and spin down) are separated from each other by being sent along different wires, say to two different locations miles apart from each other, they each remain in superposition of both spin up and spin down. However when one superpositioned electron is measured by a detector at its destination and reduces/collapses to a particular spin, its entangled separated twin (according to entanglement) must instantaneously reduce/collapse to the complementary spin down. The experiment was actually performed in the early 1980's with two detectors separated by meters within a laboratory (Aspect et al., Phys. Rev. Lett. 48, 91-94, 1982) and showed, incredibly, that complementary instantaneous reduction did occur! Since this experimental proof of quantum entanglement, the phenomena has gained wide acceptance. Similar experiments have been done repeatedly with not only electron spin pairs, but polarized photons sent along fiber optic cables many miles apart and always results in instantaneous reduction to the complementary classical state (Tittel et al., Phys. Rev. A., 57, 3229-3232, 1998). The instantaneous, faster than light coupling, or “entanglement” remains unexplained, but is being implemented in quantum cryptography technology (Bennett et al., J. Cryptol. 5(1), 3-28, 1990). Though information may not be transferred via entanglement, useful correlations and influence may be conveyed.

There are apparently at least two methods to create entanglement. The first is to have components originally united, such as the EPR electron pairs, and then separated. A second method (“mediated entanglement”) is to begin with spatially separated non-entangled components and make simultaneous quantum measurements coherently, e.g. via laser pulsations which essentially condense components (Bose-Einstein condensation) into a single system though spatially separated.

Quantum superposition, entanglement and reduction are currently being developed for use in quantum computers. First proposed in the early 1980's (Benioff, J. Stat. Phys. 29, 515-546, 1982), quantum computers are now being developed in a variety of technological implementations (electron spin, photon polarization, nuclear spin, atomic location, magnetic flux in Josephson junction superconducting loops, etc.). Whereas conventional classical computers represent digital information as “bits” of either 1 or 0, in quantum computers, “quantum information” may be represented as quantum superpositions of both 1 and 0 (quantum bits, or “qubits”). While in superposition, qubits interact with other qubits (by entanglement) allowing computational interactions of enormous speed and near-infinite parallelism. After the computation is performed the qubits are reduced (e.g. by environmental interaction/decoherence) to specific classical states which constitute the solution (Milburn, The Feynmann Processor: Quantum Entanglement and the Computing Revolution. Helix Books/Perseus Books, Reading, Mass., 1998).

Macroscopic Quantum Entanglement

In recent years, evidence has been mounting that suggests macroscopic quantum coherence (entanglement) may be in effect. In a Bose-Einstein condensates (proposed by Bose and Einstein decades ago but realized in the 1990's) a group of atoms or molecules are brought into a quantum coherent state such that they surrender individual identity and behave like one quantum system, marching in step and governed by one quantum wave function. If one component is perturbed all components “feel” it and react accordingly. Bose Einstein condensates (“clouds”) of cesium atoms have been shown to exhibit entanglement among a trillion or so component atoms (Vulsgaard et al., Nature, 413, 400-403, 2001).

Quantum dipole oscillations within macroscopic proteins were first proposed by Frohlich (Proc. Natl. Acad. Sci. U.S.A. 72, 4211-4215, 1975) to regulate protein conformation and engage in macroscopic coherence. Conrad (Chaos, Solitons Fractals, v, 423-438, 1994) suggested quantum superposition of various possible protein conformations occur before one is selected. Roitberg et al (Science 268 (5315), 1319-1322, 1995) showed functional protein vibrations which depend on quantum effects centered in two hydrophobic phenylalanine residues, and Tejada et al (Science, 272, 424-426, 1996) have evidence to suggest quantum coherent states exist in the protein ferritin. In protein folding, non-local quantum electron spin interactions among hydrophobic regions guide formation of protein tertiary conformation (Klein-Seetharaman et al., Science, 295, 1719-1722, 2002), suggesting protein folding may rely on spin-mediated quantum computation. Other experiments have shown quantum wave behavior of biological porphyrin molecules (Hackermuller et al., Phys. Rev. Left. 91, 090408, 2003). In both benzene and porphyrin, and in hydrophobic aromatic amino acid groups in proteins such as tubulin, delocalizable electrons may harness thermal environmental energy to promote, rather than destroy, quantum states. For example, Ouyang and Awschalom (Science, 301, 1074-1078, 2002) showed that quantum spin transfer through biological benzene rings is more efficient at higher temperatures.

### SUMMARY OF THE INVENTION

A process for treating a biological tissue comprising the steps of: determining a physical state of a healthy centriole within a healthy biological tissue wherein the physical state corresponds to a healthy pattern of tubulin states of the healthy centriole; irradiating a diseased centriole within the biological tissue with photonic radiation with a power density between about 500 milliwatts per square centimeter and about 1 watt per square centimeter, without substantially increasing the temperature of the biological tissue, wherein the diseased centrosome has a diseased pattern of tubulin states, and the photonic radiation causes a physical property of the diseased centriole to be changed and thus alters the diseased pattern of tubulin states so as to substantially mimic the healthy pattern of tubulin states.

### BRIEF DESCRIPTION OF THE DRAWINGS

FIG. 1 is a schematic view of a microtubule;

FIG. 2 is a schematic view of a centrosome;

FIG. 3 is a profile of a centrosome that compares centrosome diameter to wavelength of an EM wave;

FIG. 4 is a table that illustrates the various spin states of a variety of objects;

FIG. 5 is a flow diagram of one process of the invention; and

FIG. 6 is a flow diagram of another process of the invention.

### DESCRIPTION OF THE PREFERRED EMBODIMENTS

Interiors of eukaryotic cells are structurally organized by the cell cytoskeleton which includes microtubules, actin, intermediate filaments and microtubule-based centrioles, cilia and basal bodies (Dustin, Microtubules, 2^{nd} revised ed. Springer, Berlin, 1984). Rigid microtubules are interconnected by microtubule-associated proteins (“MAPs”) to form a self-supporting, dynamic tensegrity network which, along with actin filaments, comprises a negatively-charged matrix on which polar cell water molecules are bound and ordered (Pollack, Cells, Gels and the engines of life. Ebner and Sons, Seattle, 2001).

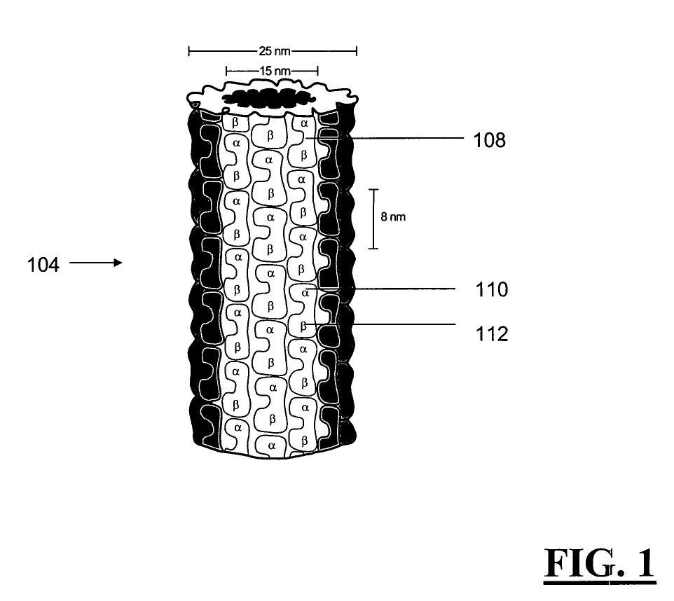

As illustrated in FIG. 1, microtubules 104 are cylindrical polymers of the protein tubulin 108 and are typically about 25 nanometers in diameter. The cylinder wails of microtubules are comprised of 13 longitudinal protofilaments which are each a series of tubulin subunit proteins 108. Each tubulin subunit is an 8 nm by 4 nm by 5 nm heterodimer which consists of two slightly different classes of 4 nm, 55,000 dalton monomers known as alpha tubulin 110 and beta tubulin 112. The tubulin dimer subunits 108 within the cylinder wall are arranged in a hexagonal lattice which is slightly twisted, resulting in differing neighbor relationships among each subunit and its six nearest neighbors. Pathways along neighbor tubulins form helices which repeat every 3, 5 and 8 rows (the “Fibonacci series”). The cylinder inner core is approximately 140 nanometers in diameter and the cylinder is typically approximately 750 nanometers in length.

Biochemical energy is provided to microtubules in several ways: tubulin-bound GTP is hydrolyzed to GDP in microtubules, and MAPs which attach at specific points on the microtubule lattice are phosphorylated. In addition microtubules have been suggested to utilize nonspecific thermal energy for “laser-like” coherent pumping, for example in the gigahertz range by a mechanism of “pumped phonons” suggested by Fröhlich (Proc. Natl. Acad. Sci. U.S.A. 72, 4211-4215, 1975). Simulation of coherent phonons in microtubules suggest that phonon maxima correspond with functional microtubule-MAP binding sites (Samsonovich et al., Nanobiology, 1, 457-468, 1992). As would be apparent to one of ordinary skill the art a phonon is a quantum of acoustic or vibrational energy. A phonon is to vibration energy as a photon is to electromagnetic energy.

Within microtubules, individual tubulins may exist in different states which can change on various time scales. Permanent states are determined by genetic scripting of amino acid sequence, and multiple tissue-specific isozymes of tubulin occur. Each tubulin isozyme within a microtubule lattice may be structurally altered by “post-translational modifications” such as removal or addition of specific amino acids. Thus each microtubule may be a more-or-less stable mosaic of slightly different tubulins, with altered properties and functions accordingly (Geuens et al., J. Cell Biol. 103(5), 1883-1893. 1986).

Tubulins also change shape dynamically. In one example of tubulin conformational change observed in single protofilament chains, one monomer can shift 27 degrees from the dimer's vertical axis (Melki et al., Biochemistry 28, 9143-9152, 1989) with associated changes in the tubulin dipole (“open versus closed” conformational states). Hoenger and Milligan (J. Mol. Biol. 265(5), 553-564, 1997) showed a conformational change based in the beta tubulin subunit. Ravelli et al. (, Nature, 428, 198-202, 2004) demonstrated that the open versus closed conformational shift is regulated near the binding site for the drug colchicine. Dynamic conformational changes of particular tubulins may be influenced, or biased, by their primary or post-translational structures.

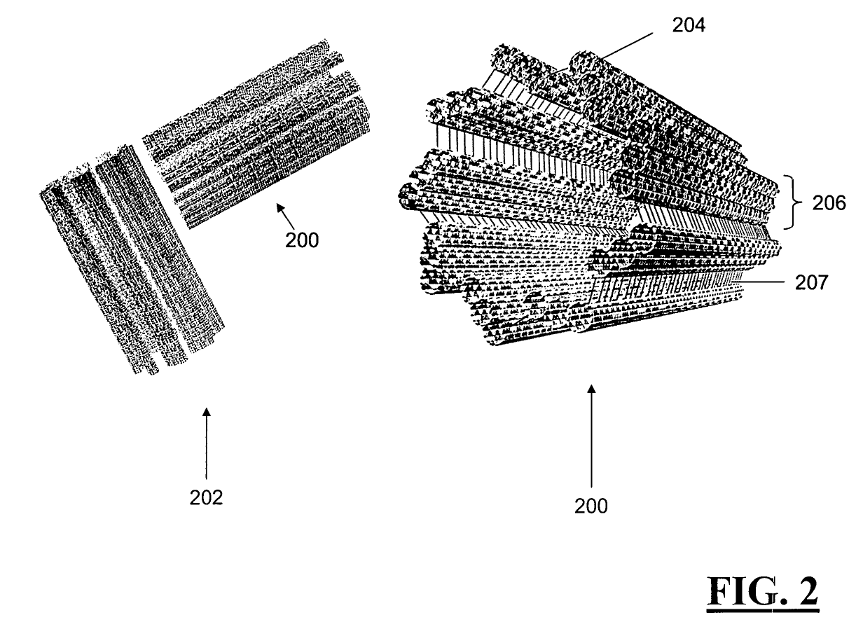

As is known to those skilled in the art, microtubles are controlled through the action of a Microtubule Organizing Center (MTOC). The MOTC within an animal cell is the centrosome. Reference may be had to FIG. 2. Each centrosome 202 comprises a pair of barrel-like structures, centrioles 200, arranged curiously in perpendicular tandem, and (like mitotic spindles) are comprised of microtubules 204. In centrioles 200, microtubules 204 are fused longitudinally into triplets 206; nine triplets are aligned, stabilized by protein struts 207 to form a cylinder which may be slightly skewed.

Centrioles are the apparatus within living cells which trigger and guide not only mitosis, but other major reorganizations of cellular structure occurring during growth and differentiation. They are the organizing center that control mitotic spindle formation and movement during mitosis, thus are critical for normal cell division. Somehow centrioles have command of their orientation in space, and convey that information to other cytoskeletal structures. Their navigation and gravity sensation have been suggested to represent a “gyroscopic” function of centrioles (Bornens; M.; The Centriole as a Gyroscopic Oscillator: Implications for Cell Organization and Some Other Consequences; Biological Cellulaire, vol. 35, no. 11, (1979) pp. 115-132). The mystery and aesthetic elegance of centrioles, as well as the fact that in certain instances they appear completely unnecessary, have created an enigmatic aura. “Biologists have long been haunted by the possibility that the primary significance of centrioles has escaped them” (Wheatley, D. N.; The Centriole: A Central Enigma of Cell Biology; Amsterdam; Elsevier; 1982).

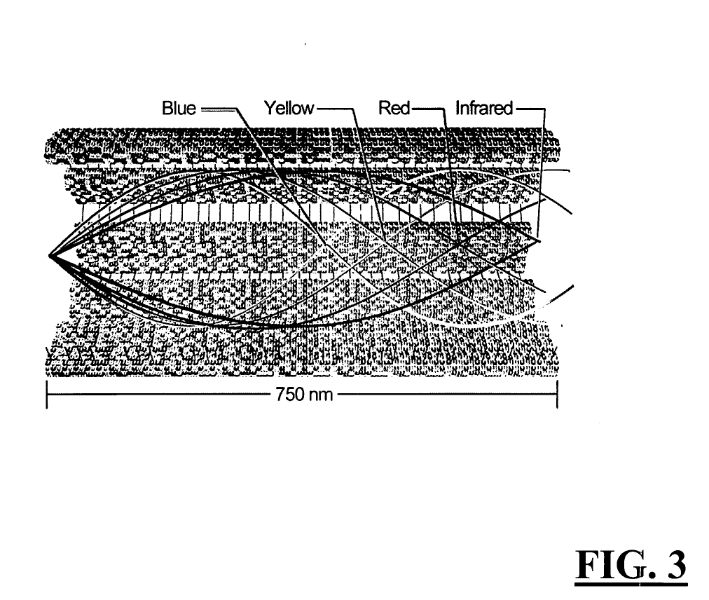

Centrioles have been found to be responsive to photonic energy. Albrecht-Buehler (Proc. Natl. Acad. Sci, U.S.A. 89(17), 8288-8292, 1992) has shown that centrioles act as the cellular “eye,” detecting and directing cell movement in response to infra-red optical signals. Cilia, whose structure is nearly identical to the cylinders which comprise centrosomes, are found in primitive visual systems as well as the rod and cone cells in our retinas. The inner cylindrical core of centrioles is approximately 140 nanometers in diameter and 750 nanometers in length, and, depending on the refractive index of the inner core, acts as a waveguide or photonic band gap device able to trap photons. Reference may be had to FIG. 3. Tong et al (Nature 426, 816-819, 2003) have shown that properly designed structures can act as sub-wavelength waveguides, e.g. diameters as small as 50 nanometers can act as waveguides for visible and infrared light.

Historic work by Gurwisch (Arch. Entw. Mech. Org. 51, 383-415, 1922) showed that dividing cells generate photons (“mitogenetic radiation”), and recent research by Liu et al (SPIE, 4224, 186-192, 2000) demonstrates that such biophoton emission is maximal during late S phase of mitosis, corresponding with centriole replication. Van Wijk et al. (J. Photochem. Photobiol., 49, (2/3), 142-149, 1999) showed that laser-stimulated biophoton emission (“delayed luminescence”) emanates from peri-nuclear cytoskeletal structures, e.g. centrioles. Popp et al (Phys. Left. A, 292, (1/2), 98-102, 2002) have shown that biophoton emission is due to quantum mechanical “squeezed photons”, indicating quantum optical coherence. While not wishing to be bound to any particular theory, applicants believe the cylindrical structure is able to act as a waveguide or similar device and the skewed helical structure of centrioles are able to detect polarization or other quantum properties of photons such as orbital momentum.

The Bose-Einstein condensation technique that was used in the classic cesium cloud entanglement experiments and other quantum systems and holds promise for quantum information technology. The cesium cloud experiment are discussed in more detail elsewhere in this specification. Additional methods are disclosed or discussed in U.S. Pat. No. 6,473,719 (Method and apparatus for selectively controlling the Quantum State Probability Distribution of Entangled Quantum Objects); U.S. Pat. No. 6,522,749 (Quantum Cryptographic Communication Channel Based on Quantum Coherence); U.S. Pat. No. 6,480,283 (Lithography System Using Quantum Entangled Photons); U.S. Pat. No. 6,424,665 (Ultra-Bright Source of Polarization-Entangled Photons); U.S. Pat. No. 6,314,189 (Method and Apparatus for Quantum Communication); U.S. Pat. No. 5,796,477 (Entangled-Photon Microscopy, Spectroscopy, and Display); U.S. Pat. No. 6,635,898 (Quantum Computer), U.S. Pat. No. 6,753,546 (Trilayer heterostructure Josephson junctions) and the like. The content of each of these patents is hereby incorporated by reference into this specification.

In one embodiment of this invention, the aforementioned activities which result in mirror-like centriole functions are acted upon to reset the quantum state of one centriole, reverting it to its pre-disease state. In one embodiment, the physical properties of a centriole are reset via treatment with coherent photonic radiation. This alteration of the physical properties resets the quantum state of the centriole. The entangled twin centriole then reacts to this change in quantum state and is likewise reset. By irradiating multiple cells (i.e. a tissue or an entire patient) a plurality of cells are treated. In one embodiment, the qubit patterns are reset using mediated entanglement. In another embodiment, the qubit patterns are reset using pulsed laser radiation. In one embodiment the crystallographic or otherwise obtained information demonstrating the physical state of the healthy centriole will be used to customize the laser irradiation of the diseased tissue/centrioles.

In one embodiment, the photonic radiation is coherent radiation with a narrow band wavelength of from about 400 nm to about 1060 nm. In another embodiment, the wavelength is from about 400 nm to about 800 nm. In another embodiment, the wavelength is from about 600 nm to about 750 nm. In another embodiment, the photonic radiation is non-coherent radiation with a range of wavelengths from about 400 nm to about 1060 nm. In another embodiment the photonic radiation is an interference pattern between two or more coherent laser sources.

In one embodiment coherent photonic radiation is used to inhibit mitosis in cancerous tissue by radiation with a power density between about 500 milliwatts per square centimeter and about 1 watt per square centimeter, without substantially increasing the temperature of said biological tissue but the power density is selected so as to disable or disassemble the centrioles due to the resultant optical resonant effects. This embodiment of the invention thus operates within a window of intensity; lower level photonic irradiation is known increase centriole replication, which is undesirable; higher levels result in heating of the tissue, which is likewise undesirable.

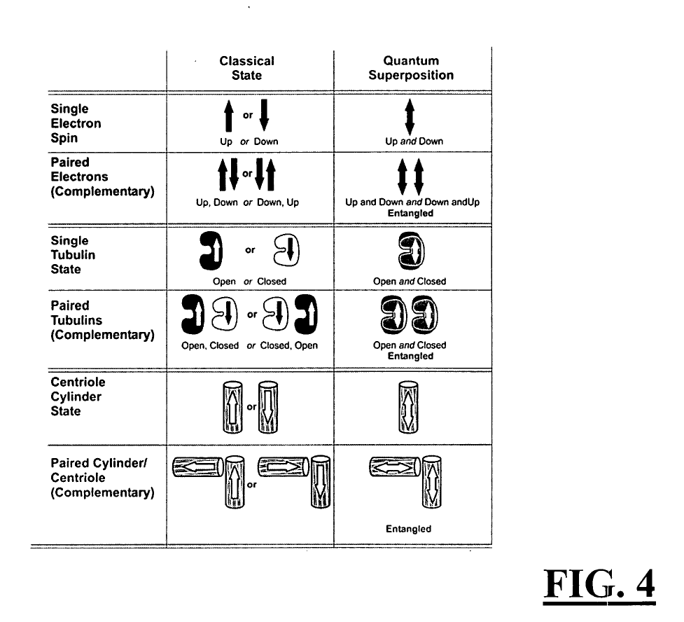

As previously discussed, within microtubules, individual tubulins exist in different states which can change on various time scales. Reference may be had to FIG. 4. In FIG. 4 the state of each centriole is euphemistically represented as either spin up or down (right or left). In actuality the states of each centriole are far more complex, since each tubulin could be in one particular binary state. There are approximately 30,000 tubulins per centriole cylinder. If each tubulin can be in one of two possible states, each centriole could be in one of 2^{30,000} possible states. Considering variations in isozymes and post-translational modifications, each tubulin may exist in many more than two possible states (e.g. 10), and centrioles may therefore exist in up to 10^{30,000} possible states. A variety of forces act upon the tubulins to generate these states, each of which corresponds with a particular state of cellular differentiation.

The types of forces operating among amino acid side groups within a protein include charged interactions such as ionic forces and hydrogen bonds, as well as interactions between dipoles—separated charges in electrically neutral groups. Dipole-dipole interactions are known as van der Waals forces and include three types: (1) permanent dipole-permanent dipole, (2) permanent dipole-induced dipole, and (3) induced dipole-induced dipole. Induced dipole-induced dipole interactions are the weakest but most purely non-polar. They are known as London dispersion forces, and although quite delicate (40 times weaker than hydrogen bonds) are numerous and highly influential. The London force attraction between any two atoms is usually less than a few kilojoules, however thousands occur in each protein. As other forces cancel out, London forces in hydrophobic pockets tend to govern protein conformational states.

London forces ensue from the fact that atoms and molecules which are electrically neutral and (in some cases) spherically symmetrical, nevertheless have instantaneous electric dipoles due to asymmetry in their electron distribution: electrons in one cloud repel those in the other, forming dipoles in each. The electric field from each fluctuating dipole couples to others in electron clouds of adjacent non-polar amino acid side groups. Due to inherent uncertainty in electron localization, the London forces which regulate tubulin states are quantum mechanical and subject to quantum uncertainty. While not wishing to be bound to any particular theory, applicants believe that 1) tubulins in microtubules and centrioles can act as qubits, and 2) centrioles, which are comprised of tubulin, are entangled through quantum entanglement and remain entangled after separation.

The enigmatic perpendicular centriole replication provides an opportunity for each tubulin in a mature (“mother”) centriole to be transiently in contact, either directly or via filamentous proteins, with a counterpart in the immature (“daughter”) centriole. Thus the state of each tubulin (genetic, post-translational, electronic, and conformational) may be relayed to its daughter counterpart tubulin in the replicated centriole, resulting in an identical or complementary mosaic of tubulins, and two identical or complementary centrioles. Assuming proteins may exist in quantum superposition of states, transient contact of tubulin twins during centriole replication would enable quantum entanglement so that subsequent states and activities of originally coupled tubulins within the paired centrioles would be unified. Then if a particular tubulin in one centriole cylinder is perturbed (“measured”), or its course or activities altered, its twin tubulin in the paired centriole “feels” the effect and respond accordingly in a fashion analogous to quantum entangled EPR pairs. Thus activities of replicated centrioles are mirror-like, precisely what is needed for normal mitosis. While not wishing to be bound to any particular theory, applicants believe that abnormal or absent entanglement between centrioles leads to abnormal distribution of chromosomes, aneuploidy, genomic instability and cancer.

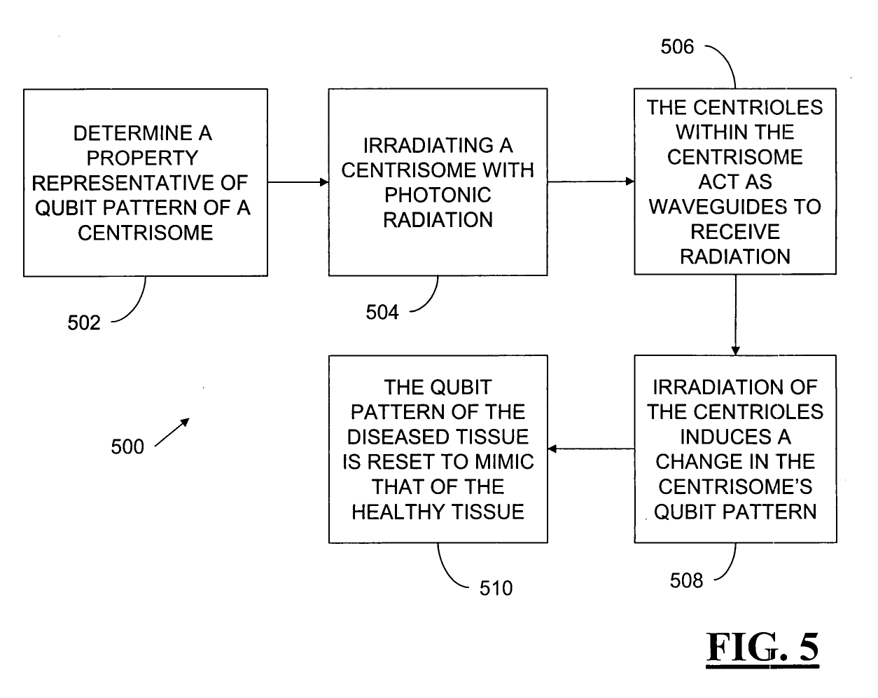

In one embodiment, diseased cells are treated. In one embodiment of the invention, cancer cells are treated. Reference may be had to FIG. 5 and the process 500 depicted therein. In step 502 the quantum state of a centriole of a non-diseased cell is determined through conventional means. Thus, for example, one may use optical diffraction, optical spectroscopy, and/or optical crystallography. Optionally, in one embodiment, the qubit pattern of a centriole of a diseased cell is determined. In step 504 of the process 500, the diseased cell is irradiated with photonic energy. In step 506, the centrioles of the diseased tissue act as waveguides and receive the photonic energy. In step 508, this energy causes the qubit pattern of the centriole to be reset. As would be apparent to one skilled in the art, one may select the parameters of the radiation to achieve the desired qubit pattern. In step 510, the quantum state (qubit pattern) of the centriole of the diseased cell is thus reset to match that of the non-diseased cell. Similar control of qubit patterns has been previously demonstrated. For example, the techniques of quantum computing routinely involve such control. In one embodiment, this is accomplished through the use of mediated entanglement via coherent photonic radiation. This quantum state is then communicated to the entangled twin, which is similarly reset. This in manner, diseased tissue is converted to non-diseased tissue. One embodiment of the invention is characterized by the conversion of diseased cells to non-diseased cells without terminating the cell.

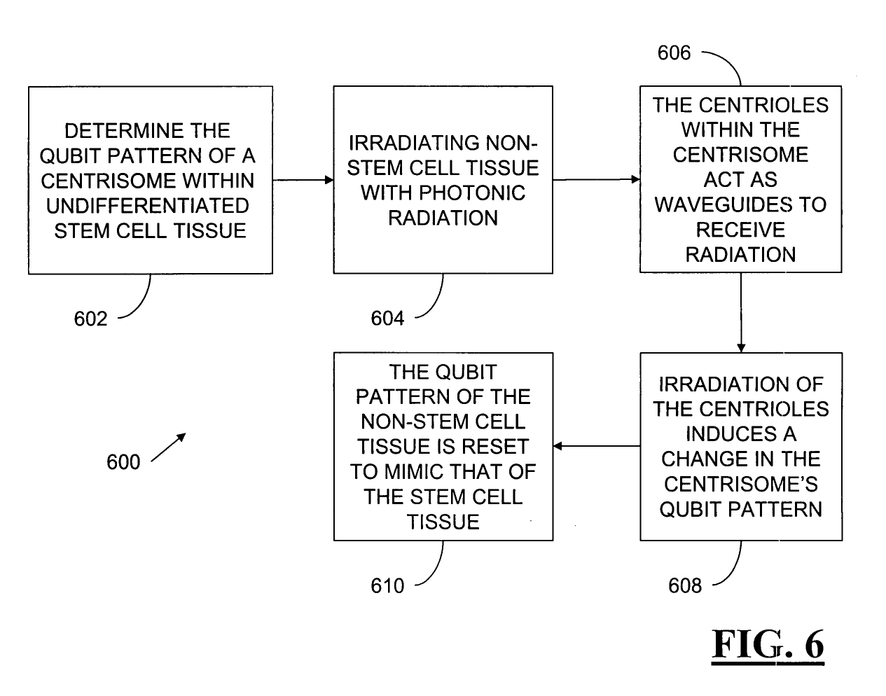

In another embodiment, non-diseased cells are treated. Reference may be had to FIG. 6 and the process 600 depicted therein. In step 602 the quantum state of a centriole of a stem cell is determined through conventional means. In one embodiment, the physical state of a centriole is determined, and this physical stated is correlated to a quantum state. In one such embodiment, the physical state is determined by nanoscale x-ray imaging (reference may be had to an article available on the internet at www.biomed.drexel.edu/BioNano/Contents/Chang/Overview/. In another such embodiment, the physical state is determined by cryo-electron microscopy (reference may be had to the J. Mol. Bio., 297, 1087-1103, 2000). Other methods for determining microtubule patterns are well known to those skilled in the art. Additional reference may be had to J. Cell Biol. 120(4), 935-945 (1993). In one embodiment a differentiated cell is reverted to a stem cell by photonic radiation by resetting the qubits to random. The blank slate/stem cell centriole is then photonically irradiated with optical characteristics of healthy differentiated tissue centrioles. As would be apparent to one skilled in the art, the ability to control the state of differentiation of a cell, tissue, organ or organism would be capable of treating a variety of disease states, countering aging, and the like. In one embodiment, the qubit pattern of a non-stem cell is determined. In step 604 of the process 600, the non-stem cell is irradiated with photonic energy. The step 606, the centrioles of the non-stem tissue act as waveguides and receive the photonic energy. In step 608, this energy causes the qubit pattern of the centriole to be reset. As would be apparent to one skilled in the art, one may select the parameters of the radiation to achieve the desired qubit pattern or physical state resulting in a particular qubit pattern. In step 610, the quantum state (qubit pattern) of the centriole of the non-stem cell is thus reset to match that of the stem cell.

Implantable Device

In one embodiment of the invention, a device is implanted within a biological organism which delivers the aforementioned photonic radiation to biological tissue within the organism. Such a device is comprised of a source of photonic radiation placed near the tissue to be treated. In one embodiment, the device is activated by remote telemetry. When the device is activated, photonic radiation is emitted from the device and irradiates the tissue. In one embodiment, fiber optic cables are used to promote the precise delivery of the radiation. Suitable photonic radiation sources and devices include U.S. Pat. No. 6,653,618 (Contact Detecting Method and Apparatus for an Optical Radiation Handpiece); U.S. Pat. No. 6,562,029 (Energy Irradiation Apparatus); U.S. Pat. No. 6,517,532 (Light Energy Delivery Head); U.S. Pat. No. 6,099,554 (Laser Light Delivery Method); U.S. Pat. No. 5,978,541 (Custom Cylindrical Diffusion Tips); U.S. Pat. No. 6,379,347 (Energy Irradiation Apparatus); U.S. Pat. No. 6,283,958 (Laser Applicator Set); and the like.

As used in this specification, the term “healthy centrosome” refers to the centrosome contained within a healthy (i.e. non-diseased) cell. Likewise the term “diseased centrosome” refers to the centrosome contained within a diseased cell. Examples of diseases which may afflict such cells include cancer, Alzheimer's disease, Huntington's disease, heart disease, arthritis, other diseases related to microtubules and microtubule associated proteins, and the like.

The term “normalized” refers to the act of returning a diseased cell to a non-diseased state. For example, the mitotic cycle of a cancerous cell may be normalized to substantially mimic the mitotic cycle of a non-cancerous cell. Non-diseased cells are therefore said to be undergoing “normal” cell division.

As used in this specification, the term “determining a physical state” means measuring optical diffraction pattern of centriole in normal, non-cancerous cell of the same tissue.

The phrase “substantially mimic” means to cause two entities to become so similar that they are phenotypically identical. Thus, there may be minor differences, but those differences are so small that they do not present themselves in the resulting phenotype. For example, the mitotic cycle of a cancerous cell may be caused to substantially mimic the mitotic cycle of a non-cancer cell. The resulting cell may have minor differences relative to the non-cancerous cell, but those differences to not present themselves in the phenotype of the converted cell (i.e. the cell is no longer cancerous).

It is to be understood that the aforementioned description is illustrative only and that changes can be made in the apparatus, in the ingredients and their proportions, and in the sequence of combinations and process steps, as well as in other aspects of the invention discussed herein, without departing from the scope of the invention as defined in the following claims.

1. A process for treating a biological tissue comprising the steps of
a. determining a physical state of a healthy centriole within a healthy biological tissue wherein said physical state corresponds to a healthy tubulin pattern of said healthy centriole,
b. irradiating a diseased centriole within said biological tissue with photonic radiation with a power density between about 500 milliwatts per square centimeter and about 1 watt per square centimeter, without substantially increasing the temperature of said biological tissue, wherein said diseased centrosome has a diseased tubulin pattern,
c. said photonic radiation causes a physical property of said diseased centriole to be changed and thus alters said diseased tubulin pattern so as to substantially mimic said healthy tubulin pattern.

2. The process as recited in claim 1 wherein said photonic radiation is coherent photonic radiation.

3. The process as recited in claim 2, wherein said photonic radiation has a wavelength from about 400 nm to about 1060 nm.

4. The process as recited in claim 3, wherein said biological tissue is disposed within a biological organism.

5. The process as recited in claim 3, wherein said biological tissue is disposed substantially on the surface of a biological organism.

6. The process as recited in claim 4, wherein said photonic radiation is emitted from a source that is implanted within a biological organism.

7. The process as recited in claim 6, wherein said biological organism is a human being.

8. A process for treating a biological tissue comprising the steps of
a. determining a physical state of a centriole within a stem cell wherein said physical state corresponds to a stem cell tubulin pattern,
b. irradiating a non-stem cell centriole with photonic radiation with a power density between about 500 milliwatts per square centimeter and about 1 watt per square centimeter, without substantially increasing the temperature of said biological tissue, wherein said non-stem cell centrosome has a non-stem cell tubulin pattern,
c. said photonic radiation causes a physical property of said non-stem cell centriole to be changed and thus alters said non-stem cell tubulin pattern so as to substantially mimic said stem cell tubulin pattern.

9. The process as recited in claim 8 wherein said photonic radiation is coherent photonic radiation.

10. The process as recited in claim 9, wherein said photonic radiation has a wavelength from about 400 nm to about 1060 nm.

11. The process as recited in claim 10, wherein said biological tissue is disposed within a biological organism.

12. The process as recited in claim 10, wherein said biological tissue is disposed substantially on the surface of a biological organism.

13. The process as recited in claim 11, wherein said photonic radiation is emitted from a source that is implanted within a biological organism.

14. The process as recited in claim 13, wherein said biological organism is a human being.

15. A process for treating a biological tissue comprising the steps of
a. irradiating a biological tissue with coherent photonic radiation with a power density between about 500 milliwatts per square centimeter and about 1 watt per square centimeter wherein said biological tissue comprised of a cell comprised of a centrosome,
b. said centrosome receives said photonic radiation,
c. a mitotic cycle of said cell is normalized as a result of exposure to said photonic radiation, wherein said photonic radiation does not substantially increase the temperature of said biological tissue.

16. A process for treating a biological tissue comprising the steps of
a. determining a physical state of a first centriole within a biological tissue wherein said physical state corresponds to a first tubulin pattern of said first centriole,
b. determining a photonic energy pattern that corresponds to said first tubulin pattern,
c. irradiating a second centriole within said biological tissue with said photonic radiation with a power density between about 500 milliwatts per square centimeter and about 1 watt per square centimeter, without substantially increasing the temperature of said biological tissue, wherein said second centrosome has a second tubulin pattern,
d. said photonic radiation causes a physical property of said second centriole to be changed and thus alters said second tubulin pattern so as to substantially mimic said first tubulin pattern.

17. The process as recited in claim 16 wherein said photonic radiation is coherent photonic radiation.

18. The process as recited in claim 17, wherein said photonic radiation has a wavelength from about 400 nm to about 1060 nm.

19. The process as recited in claim 18, wherein said biological tissue is disposed within a biological organism.

20. The process as recited in claim 19, wherein said photonic radiation is emitted from a source that is implanted within a biological organism.
